(19) United States
(12) Patent Application Publication
(10) Pub. No.: US 2015/0191314 A1
(43) Pub. Date: Jul. 9, 2015

(54) GRANULAR MATERIAL SHOOTER

(71) Applicant: Allen James Landry, Napoleonville, LA (US)

(72) Inventor: Allen James Landry, Napoleonville, LA (US)

(21) Appl. No.: 14/591,182

(22) Filed: Jan. 7, 2015

Related U.S. Application Data
(60) Provisional application No. 61/924,514, filed on Jan. 7, 2014.

(51) Int. Cl. B65G 31/04; B65G 65/48

(52) U.S. Cl. CPC B65G 31/04; B65G 65/4881

(57) ABSTRACT

A granular material shooter is provided. The shooter includes a hopper with a top end and a bottom end. The top end includes a top rim forming an opening leading into the hopper. The bottom end comprises a bottom rim forming an opening. The present invention includes a base that supports the shooter in an upright position when the base is resting on a surface. The present invention includes a rotary housing mounted to the bottom rim so that the hopper leads into the rotary housing. A rotor assembly is suspended within the rotary housing and includes a plurality of blades. A motor assembly rotates the plurality of blades. The present invention further includes a shoot extending from the rotary housing below the hopper. The shoot is directed to propel a granular material away from the hopper and the surface.

### CROSS-REFERENCE TO RELATED APPLICATION

This application claims the benefit of priority of U.S. provisional application No. 61/924,514, filed Jan. 7, 2014, the contents of which are herein incorporated by reference.

### BACKGROUND OF THE INVENTION

The present invention relates to piling sugar or other granular materials and, more particularly, to a granular material shooter.

Sugar may be stored in warehouses in large piles. The current device that piles the sugar includes a hopper and conveyor belt system with rollers. The sugar is conveyed to the top of the pile. Frequently, the rollers need to be aligned and the belts need to be replaced when the cleats of the belts wear down. The replacement of these parts is costly and labor intensive.

As can be seen, there is a need for a low maintenance device that displaces sugar or other granular materials in a pile.

### SUMMARY OF THE INVENTION

In one aspect of the present invention, a granular material shooter comprises: a hopper comprising a top end and a bottom end, wherein the top end comprises a top rim forming an opening leading into the hopper, and a the bottom end comprises a bottom rim forming an opening; a base configured to suspend the hopper in an upright position when resting on a surface; a rotary housing mounted to the bottom rim so that the hopper leads into the rotary housing; a rotor assembly suspended within the rotary housing and comprising a plurality of blades; a motor assembly configured to rotate the plurality of blades; and a shoot extending from the rotary housing below the hopper, wherein the shoot is directed to propel a granular material away from the hopper and the surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a rear view of an embodiment of the present invention;

FIG. 3 is a side view of an embodiment of the present invention omitting support structure for clarity;

FIG. 4 is a section detail view of the present invention along line 4-4 in FIG. 3; and

FIG. 5 is a section detail view of the present invention along line 5-5 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a hopper that slings raw sugar or other granular materials into a pile for storage in a warehouse. The hopper of the present invention includes an internal fan for propelling the sugar. The hopper itself may be a four sided upside down pyramid, with a constant taper that feeds raw sugar to a horizontal fan.

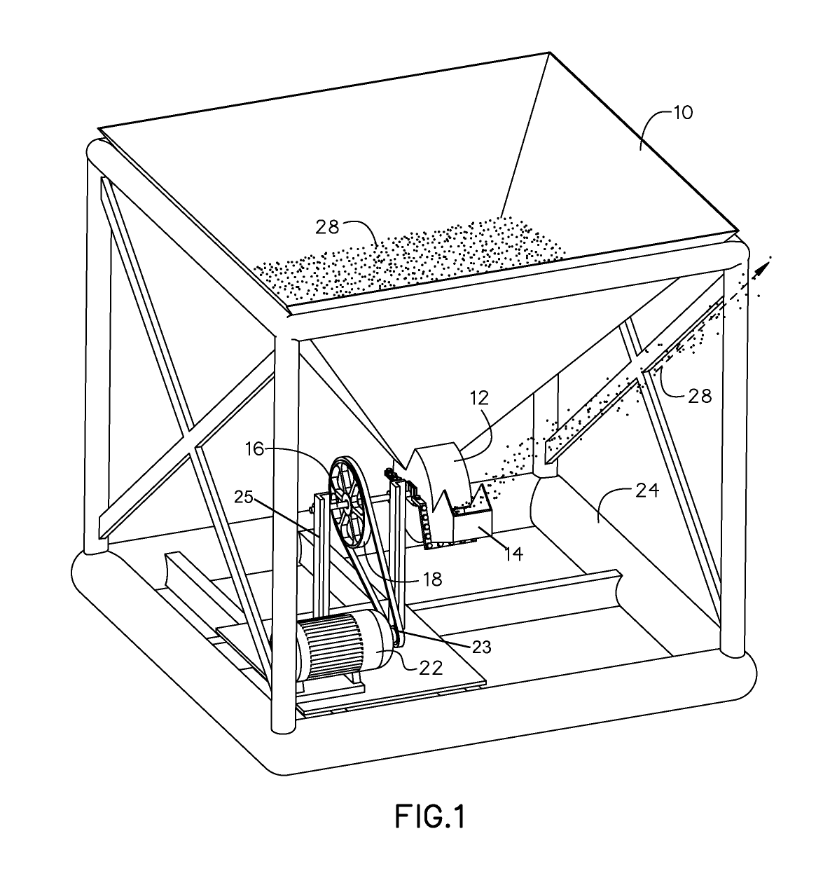

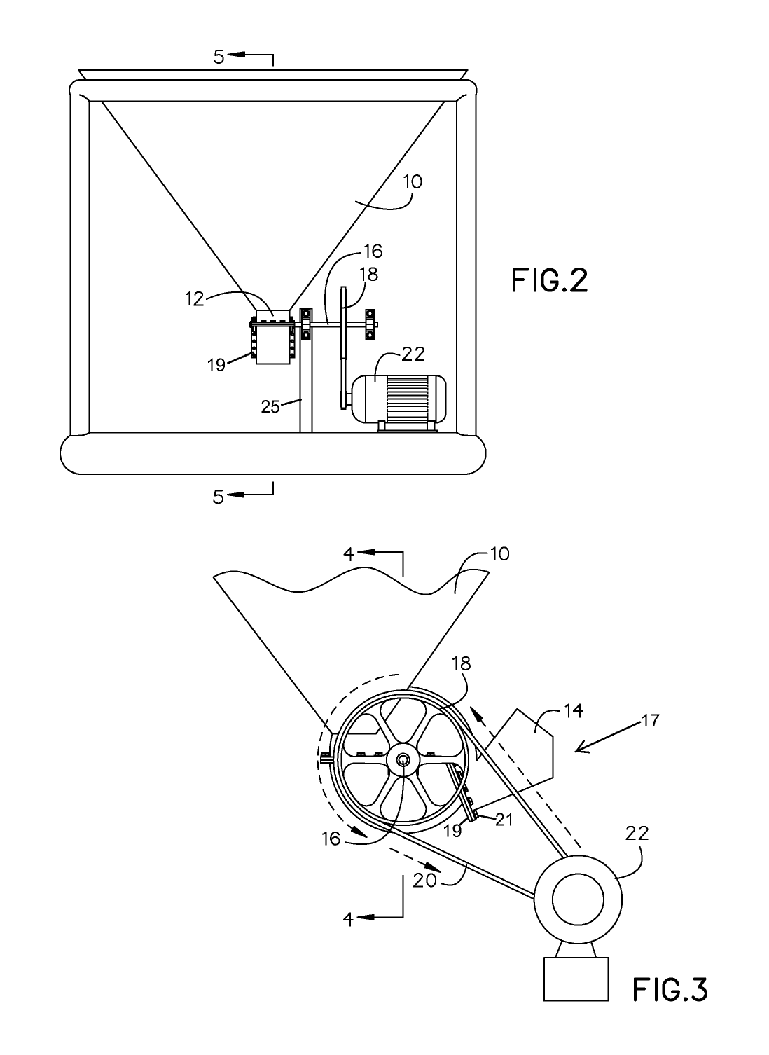

Referring to FIGS. 1 through 5, the present invention includes a granular material shooter. The shooter includes a hopper 10 with a top end and a bottom end. The top end includes a top rim forming an opening leading into the hopper. The bottom end includes a bottom rim forming an opening. The present invention includes a base 24 that supports the shooter in an upright position when the base 24 is resting on a surface. The present invention includes a rotary housing 12 mounted to the bottom rim so that the hopper 10 leads into the rotary housing 12. A rotor assembly 30 is suspended within the rotary housing 12 and includes a plurality of blades 15. A motor assembly 17 rotates the plurality of blades 15. The present invention further includes a shoot 14 extending from the rotary housing 12 below the hopper 10. The shoot 14 is directed to propel a granular material 28 away from the hopper 10 and the surface.

In certain embodiments, the rotary housing 12 may be split into a top half and a bottom half so that a user may take the housing 12 apart to replace the rotor assembly 30. As illustrated in the Figures, each half of the housing 12 may include flanges 19. The flanges 19 may be bolted together by a plurality of screws 21. Therefore, when the rotor assembly 30 needs to be repaired, a user may remove the bottom half of the housing 12 and easily gain access to the internals of the rotor assembly.

The present invention may further include a diverter 34 to prevent jamming of the rotor assembly 30. The diverter 34 may include a first end and a second end attached to opposing sides of the inner surface of the hopper 10. The diverter 34 may include a top edge and a first side and second side. The first side and the second side extend downward from the top edge away from another with the top edge facing the top opening. Therefore, the diverter 34 is triangular shaped which may be centered over the rotor assembly 30. Two equal sized openings are formed in between the diverter 34 and the inner surface of the hopper 30. The openings lead to the rotary housing 12 and thereby to the rotor assembly 30 and feeds sugar on either side of the blades 15.

The motor assembly 17 may include at least a motor 22 with a first wheel 23 extending from the motor 22. The first wheel 23 is rotated by the motor 22. An axel shaft 16 is attached to the rotor assembly 30 and extends from the rotary housing 12. A second wheel 18 is attached to the axel shaft 16 and a belt 20 connects the first wheel 23 and the second wheel 18. Therefore, when the motor is operated, the first wheel 23 turns the second wheel 18 via the belt 20. The second wheel turns the axel shaft 16 and the axel shaft 16 turns the rotor assembly 30, thereby propelling the blades 15.

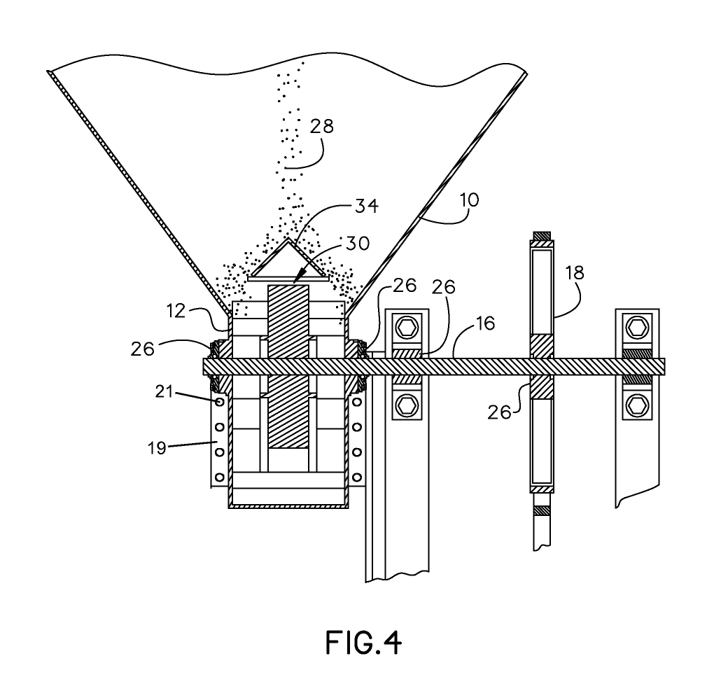

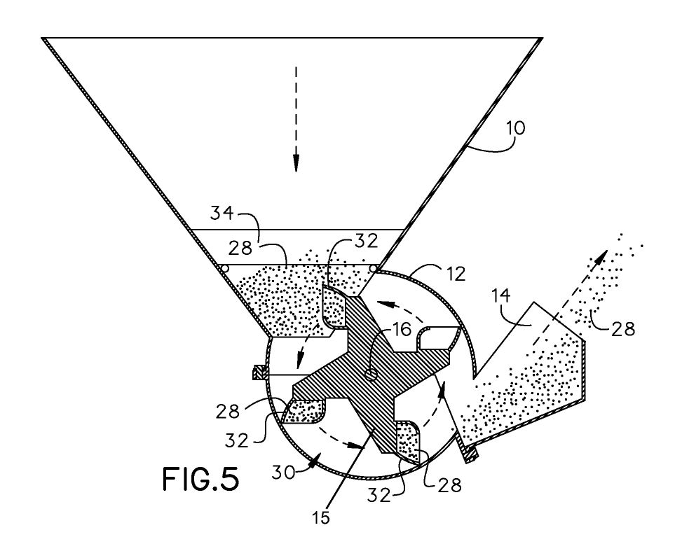

In certain embodiments, the present invention may utilize bearings 26. As illustrated in FIG. 4, the axel shaft 16 may run completely across the housing 12 and may be attached on either side of the housing 12 by bearings 26. Bearings 26 on both sides of housing 12 are utilized for more support and bearings 26 last longer because of the prevention of wobbling. A bearing 26 may also attach the second wheel 18 and the axel shaft 16 together. In certain embodiments, the present invention may include supports 25 extending from the base 24 and attached to the axel shaft 16 by the bearings 26. The supports 25 may be used to further support the motor assembly 17 and prevent malfunction.

In use, the granular material shoot is placed in a warehouse in which granular material 28, such as sugar, is to be stored. The motor 22 may turned one and the blades 15 may begin to propel. The granular material 28 is placed through the opening of the top rim of the hopper 10. The granular material 28 is diverted by the diverter 34 to either side within the rotary housing 12 and onto the rotor assembly 30. Scoops 32 formed on the end of each of the blades 15 may receive a portion of the granular material 28 and swing the granular material out of the shoot 14. Since the shoot 14 is pointed upward and away from the hopper 10, the granular material 28 is launched to a top of a pile.

It should be understood, of course, that the foregoing relates to exemplary embodiments of the invention and that modifications may be made without departing from the spirit and scope of the invention as set forth in the following claims.

What is claimed is:

1. A granular material shooter comprising:
a hopper comprising a top end and a bottom end, wherein the top end comprises a top rim forming an opening leading into the hopper, and a the bottom end comprises a bottom rim forming an opening;
a base configured to suspend the hopper in an upright position when resting on a surface;
a rotary housing mounted to the bottom rim so that the hopper leads into the rotary housing;
a rotor assembly suspended within the rotary housing and comprising a plurality of blades;
a motor assembly configured to rotate the plurality of blades; and
a shoot extending from the rotary housing below the hopper, wherein the shoot is directed to propel a granular material away from the hopper and the surface.

2. The granular material shooter of claim 1, further comprising a diverter comprising a first end and a second end, wherein the first end and the second end are attached to opposing sides of an inner surface of the hopper.

3. The granular material shoot of claim 2, wherein the diverter comprises a top edge, and a first side and a second side, wherein the first side and the second side extend downward from the top edge away from one another, and therein the top edge is facing the top opening.

4. The granular material shoot of claim 3, wherein two equal sized openings are formed in between the diverter and the inner surface of the hopper, wherein the equal sized openings lead to the rotary housing.

5. The granular material shoot of claim 1, wherein the motor assembly comprises:
a motor;
a first wheel extending from the motor, wherein the motor is operable to rotate the first wheel;
an axel shaft attached to the rotor assembly and extending from the rotary housing;
a second wheel attached to the axel shaft; and
a belt connecting the first wheel and the second wheel.

6. The granular material shoot of claim 6, wherein the second wheel and the rotor assembly are each attached to the axel shaft by a bearing.

7. The granular material shoot of claim 6, further comprising at least one support extending from the base and attached to the axel shaft by the bearing.

8. The granular material shoot of claim 1, wherein each of the plurality of blades comprises a scoop formed to receive a portion of the granular material and launch the portion of granular material out of the shoot.
